(19) United States
(12) Patent Application Publication
(10) Pub. No.: US 2020/0016670 A1
(43) Pub. Date: Jan. 16, 2020

(54) PLASTIC TUBE CUTTER

(71) Applicant: Hsin-Ping Wang, Taichung City (TW)

(72) Inventor: Hsin-Ping Wang, Taichung City (TW)

(21) Appl. No.: 16/035,698

(22) Filed: Jul. 15, 2018

(51) Int. Cl. B23D 21/10; B26D 3/16

(52) U.S. Cl. CPC B23D 21/10; B26D 3/169

(57) ABSTRACT

The plastic tube cutter comprises: a shell-body; a cutting-unit; and a pressing-arm; wherein the cutting-unit having a semicircular concave-arc end-face at one end is pivotally set in the shell-body; wherein four rolling-wheels corresponding to each other are spacedly set on two sides between the concave-arc end-face and the opening, and the other end of the shell-body has a gripping-arm; wherein the pressing-arm is pivotally set at the bottom of the shell-body and spaced apart from the gripping-arm to face with each other; wherein the four rolling-wheels of the semicircular concave-arc end-face are provided for accommodating a plastic tube body. In addition, a hooking-piece and a rod-body are respectively set on opposite sides of the gripping-arm and the pressing-arm to hook the hooking-piece and the rod-body. Therefore, maintaining the cutting freedom and the flat-smooth cutting, and cutting the high-thickness plastic tube body in a rotation way can be achieved.

### (a) TECHNICAL FIELD OF THE INVENTION

The present invention relates to a hand-held pressable and rotary cutting device, and especially relates to a plastic tube cutter with four rolling-wheels which can be operated with one hand and used for cutting a plastic tube body.

### (b) DESCRIPTION OF THE PRIOR ART

Generally, when the plumber technician or the decoration worker repairs at the job site, he will carry a plastic tube cutter to carry out the work of cutting the pipe.

Since the thickness and material properties of the plastic tube are different, both of the conventional scissor-type plastic tube cutter or the rolling-wheel knife-type plastic tube cutter have their disadvantages. When the scissor-type tube cutter is used to cut the thin tube, it will depress-flat the plastic tube and result in an uneven cutting surface. On the other hand, the cutting speed of the rolling-wheel knife-type tube cutter is too slow for cutting the thick tube.

Therefore, the conventional tube cutter still has the necessity of improvement.

### SUMMARY OF THE INVENTION

In view of the above disadvantages, the plastic tube cutter of the present invention comprises: a shell-body; a cutting-unit; and a pressing-arm; wherein the cutting-unit is pivotally set in the shell-body, and the shell-body has a semicircular concave-arc end-face set at one end thereof; wherein four rolling-wheels corresponding to each other are spacedly set on two sides between the concave-arc end-face and the opening, and the other end of the shell-body has a gripping-arm; wherein the pressing-arm is pivotally set at the bottom of the shell-body and spaced apart from the gripping-arm to face with each other; wherein the four rolling-wheels of the semicircular concave-arc end-face are provided for accommodating a plastic tube body.

When cutting, the user presses the pressing-arm to drive the cutting-unit to pivot, and so as to achieve the purposes of maintaining the cutting freedom and the flat-smooth cutting surface.

In addition, a hooking-piece and a rod-body are respectively set on opposite sides of the gripping-arm and the pressing-arm to hook the hooking-piece and the rod-body. And, the four rolling-wheels are used to guide correctly, and so as to achieve the purposes of cutting the high-thickness plastic tube body in a rotation way and maintaining the flat-smooth cutting surface.

### BRIEF DESCRIPTION OF THE DRAWINGS

FIG. 1 is a stereoscopic appearance diagram according to the present invention.

FIG. 2 is a stereoscopic exploded view according to the present invention.

FIG. 3 is an internal structure diagram according to the present invention.

FIG. 4 is a usage status schematic diagram according to the present invention.

FIG. 5 is an internal action schematic diagram to continue FIG. 4 according to the present invention.

FIG. 6 is a reset internal action schematic diagram according to the present invention.

FIG. 7 is an action schematic diagram of another embodiment according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following detailed description provides a convenient illustration for implementing exemplary embodiments of the invention. Various changes to the described embodiments may be made in the function and arrangement of the elements described without departing from the scope of the invention as set forth in the appended claims.

The foregoing and other aspects, features, and utilities of the present invention will be best understood from the following detailed description of the preferred embodiments when read in conjunction with the accompanying drawings.

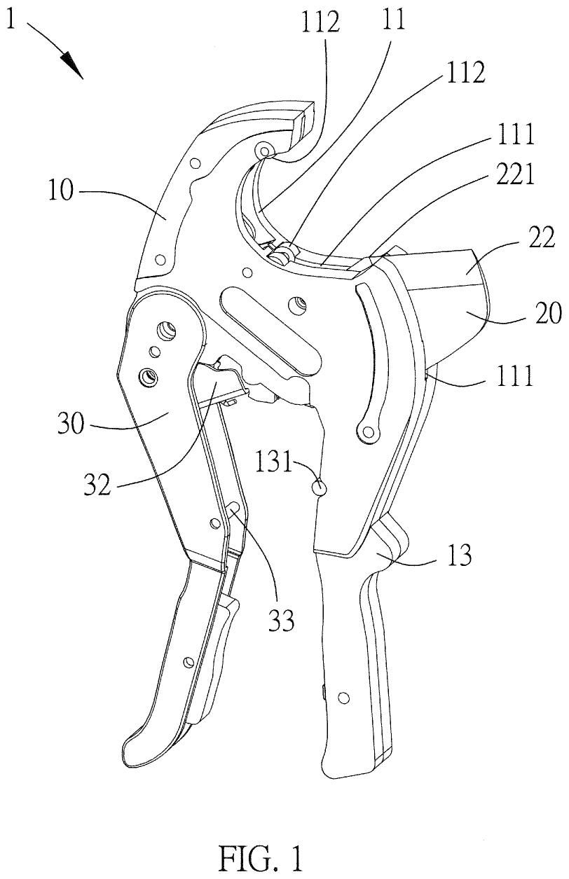

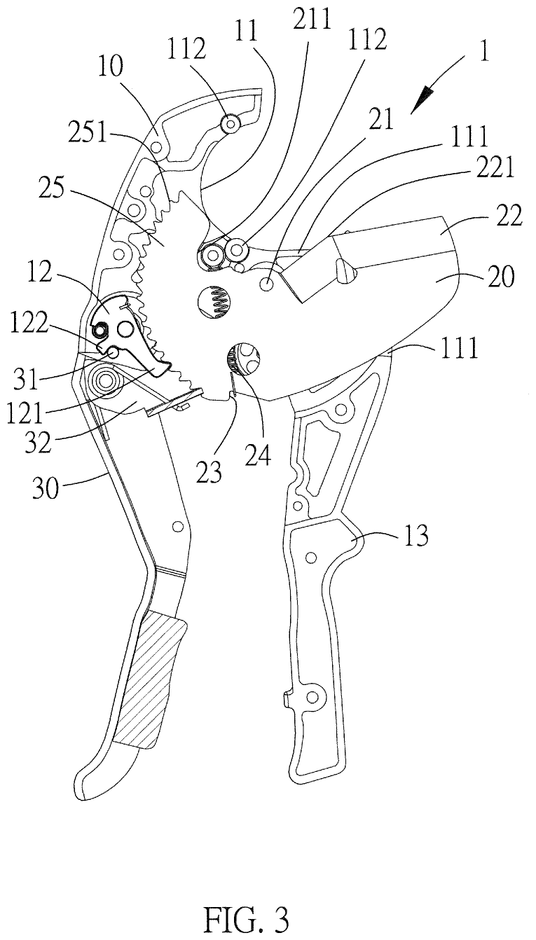

Please refer FIG. 1 to FIG. 3, the plastic tube cutter 1 of the present invention comprises: a hollow shell-body 10; a cutting-unit 20; and a hollow pressing-arm 30. The components are described as follows: The shell-body 10 has a semicircular concave-arc end-face 11 at one end thereof; wherein the semicircular concave-arc end-face 11 is set with an opening 111 communicating with the interior; wherein four rolling-wheels 112 corresponding to each other are spacedly set on two sides between the opening 111 and the concave-arc end-face 11, and one end of the opening 111 is extended to the outside of the shell-body 10; wherein a first pushing-piece 12 is elastically set inside the shell-body 10; wherein a stopping-piece 121 and a toggling-portion 122 are respectively set on two sides of the bottom of the first pushing-piece 12; wherein the other end of the shell-body 10 has a gripping-arm 13.

The cutting-unit 20 is pivotally set in the shell-body 10, and a pivot-hole 21 is set in the center of the cutting-unit 20 for providing pivotal connection inside the shell-body 10; wherein the blade-portion 22 has a protruding concave-portion 221, and the other side of the pivot-hole 21 is set with a concave-portion 211; wherein the concave-portion 211 is stopped and blocked by the interior of the shell-body 10; wherein the bottom of the cutting-unit 20 is set with a hook-portion 23; wherein the hook-portion 23 is set with a first elastic-element 24, and the other end of the first elastic-element 24 is coupled within the shell-body 10; wherein the cutting-unit 20 is pivoted in a clockwise direction by the elastic force of the first elastic-element 24, and the concave-portion 211 is used to stop and block the cutting-unit 20 from pivoting; wherein one side of the cutting-unit 20 is set with a ratchet-portion 25 having a plurality of ratchet tooth 251, and one end of the ratchet-portion 25 is adjacent to the hook-portion 23; wherein the stopping-piece of the first pushing-piece 12 is located between each of the ratchet teeth 251 to stop and block the cutting-unit 20 from pivoting.

The pressing arm 30 is pivotally set at the bottom of the shell-body 10 and spaced apart from the gripping-arm 13 to face with each other; wherein the pressing-arm 30 is set with a stopping-element 31 and a hollow second pushing-piece 32; wherein one side of the stopping-element 31 is in contact with the toggling-portion 122, and the first pushing-piece 12 is accommodated in the second pushing-piece 32; wherein the second pushing-piece 32 has a length greater than the first pushing-piece 12, so that the front end of the second pushing-piece 32 is engaged between the ratchet tooth 251.

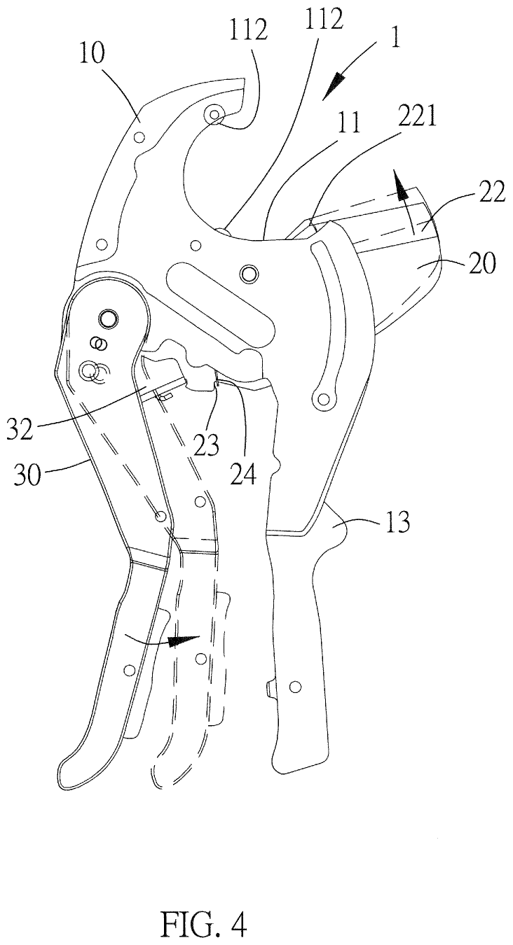

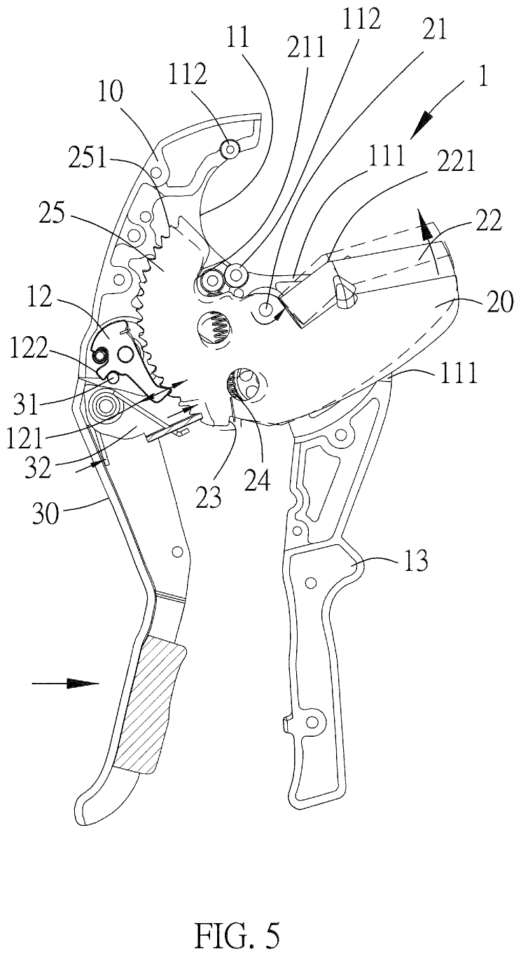

Please refer to the FIG. 4 and FIG. 5, which are the schematic diagrams showing the state of use of the plastic tube cutter according to the present invention.

The plastic tube cutter 1 of the invention is provided to cut a plastic tube body, and the semicircular concave-arc end-face 11 of the shell-body 10 is provided for accommodating the plastic tube body. The plastic tube body is supported by the four rolling-wheels 112 to facilitate the plastic tube body to maintain the freedom of the cutting and pressing during the cutting process. When cutting, the user simultaneously holds the pressing-arm 30 and the gripping-arm 13 and presses the pressing-arm 30 to pivot the pressing arm 30 toward the gripping-arm 13. At the same time, the second pushing-piece 12 pushes and butts between the ratchet tooth 251, so that the cutting-unit 20 rotates counterclockwise to move the distance of one ratchet teeth 251. After continuous pressing of the pressing arm 30, the blade-portion 22 of the cutting-unit 20 is gradually cut into the plastic tube body to achieve the purpose of complete cutting the plastic tube body. The stopping-piece 121 of the first pushing-piece 12 is engaged between the ratchet tooth 251 to prevent the cutting-unit 20 from being rotated in a clockwise rotation to restore position during cutting.

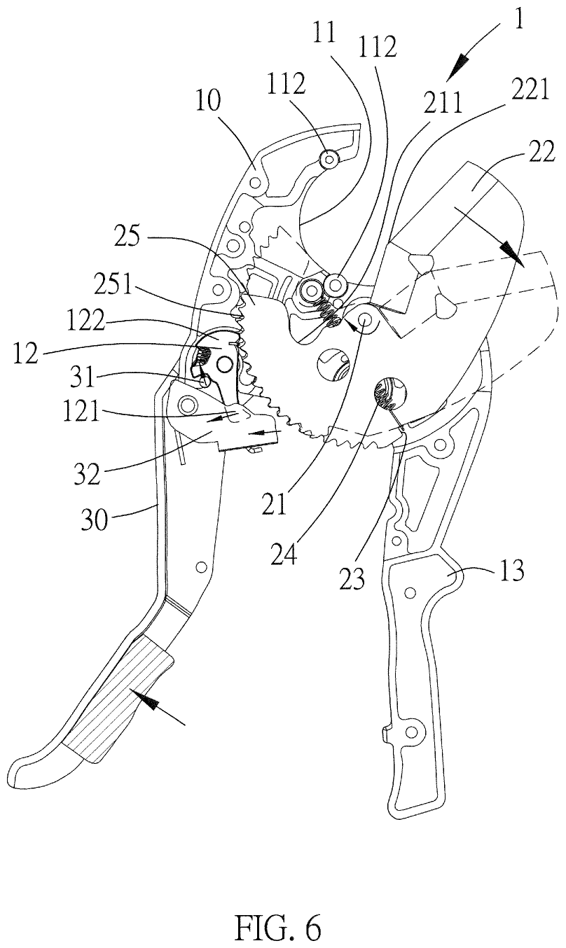

Please refer to FIG. 6, which is a schematic diagram of the resetting action of the plastic tube cutter the present invention. Continuous describing for the above, the ratchet-portion 25 of the cutting-unit 20 is engaged by the second pushing-piece 32 when the cutting is completed. Therefore, the blade-portion 22 of the cutting-unit 20 is placed in the semicircular concave-arc end-face 11. The first pushing-piece 12 and the second pushing-piece 32 are disengaged from the ratchet-portion 25 by pulling the pressing-arm 30 outward. The cutting-unit 20 is rotated clockwise by the elastic force of the first elastic-element 24, and is stopped and blocked by the concave-portion 211 to stop the cutting-unit 20 from pivoting; thereby completing the resetting action.

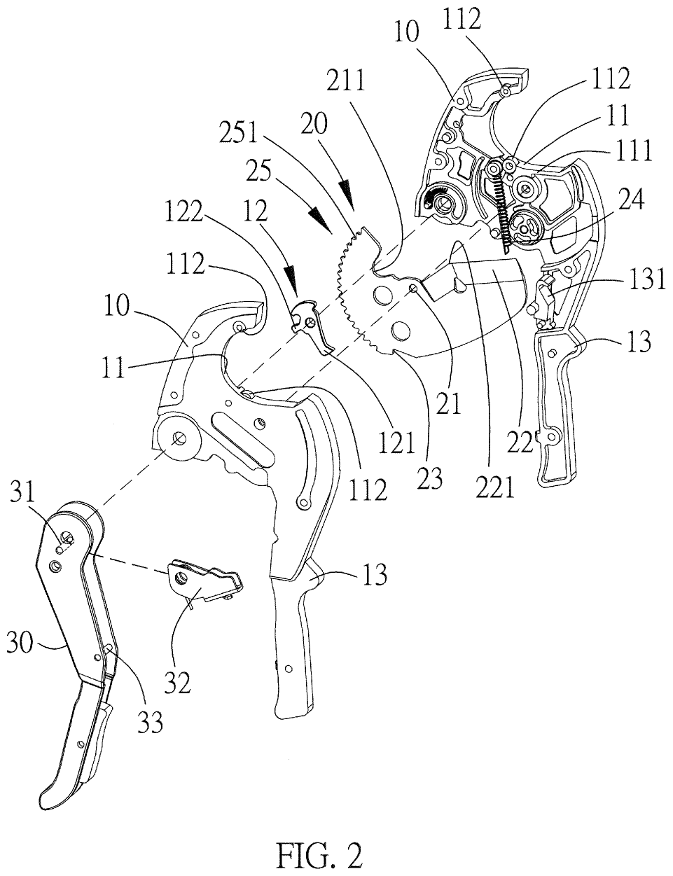

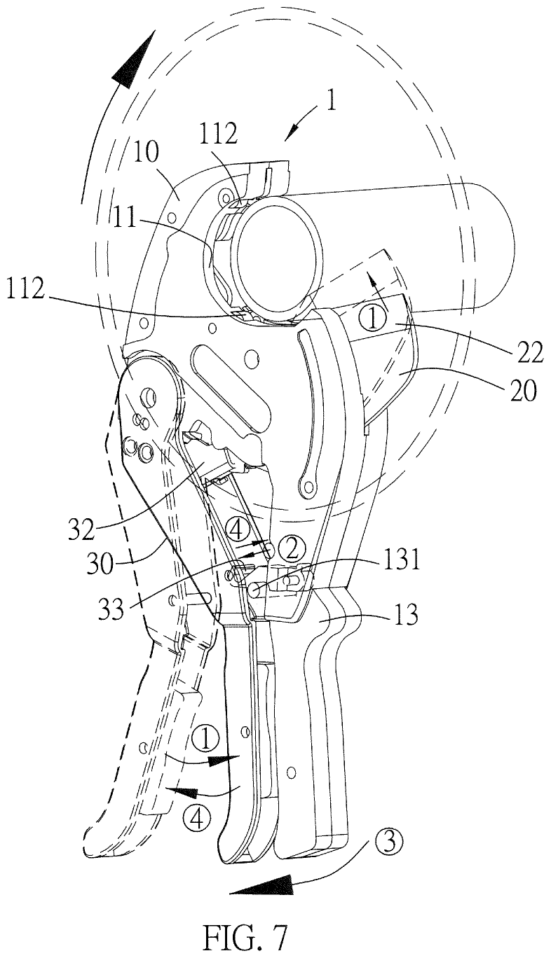

Please refer to FIG. 1, FIG. 2, and FIG. 7, which are another embodiment of the plastic tube cutter according to the present invention. Firstly, the plastic tube body is fixed in the tube clamp and the semicircular concave-arc end-face 11 of the plastic tube cutter after resetting is displaced to the position to be cut. The plastic tube body is supported by four rolling-wheels 112, please refer to FIG. 7. Then, a distance of one ratchet teeth 251 is pressed and the protruded concave-portion 221 of the blade-portion 22 is cut into the plastic tube body. At the same time, the hooking-piece 131 is hooked on the rod-body 33 to press the arm 30. The pressing-arm 30 is fixed by the gripping-arm 13 without pivoting, and the gripping-arm 13 is pushed by the plastic tube as a fixed axis to rotate toward the direction of the arrow. The concave-portion 221 of the blade is correctly guided by four rolling-wheels to rotationally cut along the outer diameter of the plastic tube body. After rotationally cutting each cycle, the hooking-piece 131 is removed from the rod-body 33, and then pressed to make the blade-portion cut into the plastic tube body deeper. At the same time, the hooking-piece 131 is hooked on the rod-body 33, and then the second rotational cutting is performed. \textcircled{1} Press to feed the blade; \textcircled{2} Hook; \textcircled{3} Rotationally cut one cycle; and \textcircled{4} Release the hooking. Repeat the above four processes \textcircled{1} \textcircled{2} \textcircled{3} \textcircled{4}, it can be quickly cut and the cut surface is flat-smooth. This method is suitable for cutting the high-thickness plastic tube body.

I claim:

1. A plastic tube cutter, which comprises:
a shell-body having a semicircular concave-arc end-face at one end thereof; wherein an opening communicating with the interior is set on the semicircular concave-arc end-face;
wherein four rolling-wheels corresponding to each other are spacedly set on two sides between the opening and the concave-arc end-face, and one end of the opening is extended to the outside of the shell-body;
wherein a first pushing-piece is elastically set inside the shell-body;
wherein a stopping-piece and a toggling-portion are respectively set on two sides of the bottom of the first pushing-piece;
wherein the other end of the shell-body has a gripping-arm;
a cutting-unit pivotally set in the shell-body, wherein a pivot-hole is set in the center of the cutting-unit for providing pivotal connection inside the shell-body;
wherein one side of the pivot-hole is set with a blade-portion that is accommodated in the shell-body and extended outside the opening;
wherein the blade-portion has a protruding concave-portion, and the other side of the pivot-hole is set with a concave-portion;
wherein the concave-portion is stopped and blocked by the interior of the shell-body;
wherein the bottom of the cutting-unit is set with a hook-portion, and the hook-portion is set with a first elastic-element;
wherein the other end of the first elastic-element is coupled within the shell-body;
wherein the cutting-unit is pivoted in a clockwise direction by the elastic force of the first elastic-element, and the concave-portion is used to stop and block the cutting-unit from pivoting;
wherein one side of the cutting-unit is set with a ratchet-portion having a plurality of ratchet tooth, and one end of the ratchet-portion is adjacent to the hook-portion;
wherein the stopping-piece of the first pushing-piece is located between each of the ratchet teeth to stop and block the cutting-unit from pivoting; and
a pressing arm pivotally set at the bottom of the shell-body and spaced apart from the gripping-arm to face with each other; wherein the pressing-arm is set with a stopping-element and a hollow second pushing-piece;
wherein one side of the stopping-element is in contact with the toggling-portion, and the first pushing-piece is accommodated in the second pushing-piece;
wherein the second pushing-piece has a length greater than the first pushing-piece, so that the front end of the second pushing-piece is engaged between the ratchet tooth.

2. The plastic tube cutter according to claim 1, wherein the inside of the gripping-arm is pivotally set with a hooking-piece, and the inner side of the pressing-arm is set with a rod-body corresponding to the hooking-piece for providing the hooking-piece to hook on the rod-body.
